(19) United States
(12) Patent Application Publication
(10) Pub. No.: US 2019/0084304 A1
(43) Pub. Date: Mar. 21, 2019

(54) PRINTING DEVICE

(71) Applicant: Seiko Epson Corporation, Tokyo (JP)

(72) Inventor: Tsuneyuki SASAKI, Matsumoto-Shi (JP)

(21) Appl. No.: 16/083,356

(22) PCT Filed: Mar. 9, 2017
(86) PCT No.: PCT/JP2017/009596

§ 371 Date: Sep. 7, 2018

(30) Foreign Application Priority Data
Mar. 11, 2016 (JP) 2016-047944

(51) Int. Cl. B41J 2/14; B41J 29/38; B41J 11/00; B65H 20/14

(52) U.S. Cl. CPC B41J 2/14233; B65H 20/14; B41J 11/002; B41J 29/38

(57) ABSTRACT

A printing device is provided that suppresses occurrence of a transport failure of a medium at a guide unit that guides the medium on which printing has been performed, regardless of a type of the medium. The printing device includes a transport unit configured to transport a medium M in a transport direction Y, a printing unit configured to perform printing on the medium M transported by the transport unit, a guide unit 33 including a guide surface 35 that guides the medium M on which printing has been performed, and a vibration unit 34 configured to vibrate the guide surface 35. The guide surface 35 is formed to be increasingly directed vertically downward while advancing in the transport direction Y.

### TECHNICAL FIELD

The present invention relates to a printing device such as an ink jet printer.

### BACKGROUND ART

In the related art, printing devices configured to print characters and images by discharging ink onto a medium such as a sheet of paper transported in a transport direction are known. Some of the printing devices include a discharge guide plate (guide unit) that guides a medium on which printing has been performed and a blowing means for blowing gas along the discharge guide plate (for example, PTL 1). In the above-described printing device, an air layer is formed by blowing gas between the medium and the discharge guide plate during transportation of the medium. This suppresses occurrence of static electricity due to friction between the medium and a discharge guide plate, and suppresses electrostatic adsorption of the medium to the discharge guide plate.

### CITATION LIST

### Patent Literature

PTL 1: JP-A-2001-80802

### SUMMARY OF INVENTION

### Technical Problem

Some printing devices may perform printing on a medium, such as cloth and mesh tarpaulin, through which gas easily passes. In this case, in the printing device as described above, an air layer cannot be formed between the medium and the discharge guide plate because gas passes through the medium, and the medium may be electrostatically adsorbed to the discharge guide plate. In other words, in the printing device as described above, a transport failure of the medium may occur at the discharge guide plate guiding the medium on which printing has been performed, depending on a type of the medium.

The present invention has been made in view of the above circumstances. Its advantage is to provide a printing device that suppresses occurrence of the transport failure of a medium at a guide unit that guides the medium on which printing has been performed, regardless of a type of the medium.

### Solution to Problem

Hereinafter, measures for eliminating the above-described issues and advantages of the measures will be described.

A printing device that eliminates the above-described issues includes a transport unit configured to transport a medium in a transport direction, a printing unit configured to perform printing on the medium transported by the transport unit, a guide unit including a guide surface that guides the medium on which printing has been performed, and a vibration unit configured to cause the guide surface to vibrate. The guide surface is formed to be increasingly directed vertically downward while advancing in the transport direction.

According to the above-described configuration, the guide surface that guides the medium on which printing has been performed is caused to vibrate, and thus electrostatic adsorption of the medium to the guide surface can be suppressed regardless of the type of the medium. Further, even when the medium is electrostatically adsorbed to the medium, the medium can be separated from the guide surface by causing the guide surface to vibrate. Furthermore, since the guide surface is formed to be increasingly directed vertically downward while advancing in the transport direction, the medium on which gravity acts is more likely to be guided in the transport direction. In this way, this configuration can suppress the transport failure of the medium at the guide unit.

Further, the above-described printing device may further include a heating unit configured to heat the medium without contact.

For example, when the medium is heated by heat transfer from the guide surface guiding the medium, that is, when the guide surface performs contact heating on the medium, efficiency of heating the medium is more likely to decrease because a period in which the guide surface is not in contact with the medium occurs when the guide surface is caused to vibrate. On the other hand, in the above-described configuration, the medium is heated without contact, and thus efficiency of heating the medium is less likely to decrease even if the period in which the guide surface is not contact with the medium occurs when the guide surface is caused to vibrate. Accordingly, even when the medium is heated, a decrease in efficiency of heating the medium due to the vibration of the guide surface can be suppressed.

Further, in the above-described printing device, the heating unit may irradiate the medium with infrared rays.

According to the above-described configuration, the medium is heated by irradiating the medium with infrared rays, and thus the configuration of the printing device can be simplified in comparison with a configuration in which the medium is heated by blowing hot air onto the medium. Further, even when the medium is heated only by irradiation with infrared rays, a boundary layer of temperature or humidity formed around the medium is easily destroyed by the vibration of the guide surface, and the medium can be prevented from becoming unlikely to dry.

Further, the above-described printing device may further include a detector configured to detect floating of the medium from the guide surface, and a control unit configured to cause the guide surface to vibrate when floating of the medium from the guide surface occurs.

When the medium is electrostatically adsorbed to the guide surface during transportation of the medium, the transportation on an upstream side in the transport direction may continue while the transportation at a downstream side in the transport direction stops. Thus, a portion of the medium being transported on the upstream side of a portion adsorbed to the guide surface in the transport direction may float from the guide surface. In this regard, the above-described configuration can separate the medium electrostatically adsorbed to the guide surface from the guide surface by vibrating the guide surface when floating of the medium from the guide surface occurs, based on a detection result of the detector. Therefore, the guide surface does not have to be continuously caused to vibrate because the guide surface vibrates when the transport failure of the medium occurs.

Further, the above-described printing device may further include a control unit configured to alternately perform a transport operation in which the medium is transported in the transport direction and a printing operation in which printing is performed on the medium, and the control unit may be configured to cause the guide surface to vibrate when the transport operation is performed, whereas the control unit may be configured to not cause the guide surface to vibrate when the printing operation is performed.

When the guide surface is caused to vibrate in the printing operation, printing quality may be affected due to vibration of the medium during printing. In this regard, according to the above-described configuration, the guide surface is not vibrated during the printing operation, whereas the guide surface is vibrated during the transport operation. Thus, occurrence of the transport failure of the medium can be suppressed while influence on printing quality is suppressed.

Further, the above-described printing device further includes a control unit configured to perform a transport operation in which the medium is transported in the transport direction, perform a printing operation in which printing is performed on the medium, and cause the guide surface to vibrate. The control unit causes the guide surface to vibrate both when the transport operation is performed and when the printing operation is performed.

The guide surface is caused to vibrate both when the printing operation is performed and when the transport operation is performed under vibration conditions where printing quality of the medium during printing is not adversely affected. Thus, the vibration is continuously applied to the medium after printing, and heating of the medium after printing is promoted, for example, drying of a printing material such as ink discharged onto the medium after printing is promoted. Therefore, occurrence of the transport failure of the medium can be suppressed while an increase in transport speed of the medium can increase print efficiency, and a lower set temperature of the heating unit can suppress thermal damage to the medium and power consumption of the heating unit.

### BRIEF DESCRIPTION OF DRAWINGS

FIG. 1 is a side view schematically illustrating a configuration of a printing device according to one exemplary embodiment.

FIG. 2 is a side view enlargedly illustrating a guide unit and a heating unit of the above-described printing device.

FIG. 3 is a flowchart illustrating a processing routine executed by a control unit of the above-described printing device to cause a guide surface to vibrate.

FIG. 4 is a side view illustrating a situation where the guide surface vibrates in the above-described printing device.

FIG. 5 is a schematic diagram illustrating a surface of a medium heated by the heating unit.

FIG. 6 is a flowchart illustrating a processing routine executed by a control unit of another modified example to cause a guide surface to vibrate.

### DESCRIPTION OF EMBODIMENTS

One exemplary embodiment of a printing device will be described below with reference to the accompanying drawings. Note that the printing device of the exemplary embodiment is an ink jet printer configured to form characters and images by discharging ink onto a printing medium.

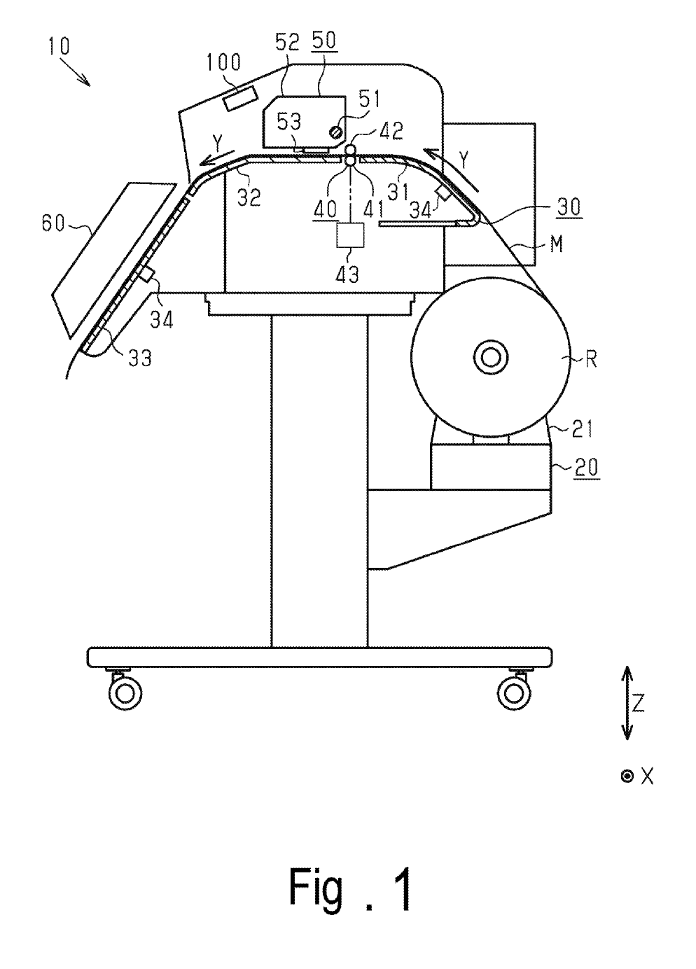

As illustrated in FIG. 1, a printing device 10 includes a feeding unit 20 configured to feed a medium M, a support unit 30 configured to support the medium M, a transport unit 40 configured to transport the medium M, a printing unit 50 configured to perform printing on the medium M, and a heating unit 60 configured to heat the medium M.

Note that, in the following description, a width direction of the printing device 10 is referred to as a “width direction X”, a direction in which the medium M is transported is referred to as a “transport direction Y”, and a vertical direction of the printing device 10 is referred to as a “vertical direction Z”. In the exemplary embodiment, the width direction X is a direction intersecting (orthogonal to) both the transport direction Y and the vertical direction Z.

The feeding unit 20 includes a holding member 21 configured to rotatably hold a roll body R on which the medium M is wound. The holding member 21 holds different types of media M and roll bodies R with different dimensions in the width direction X. Moreover, the medium M is unwound from the roll body R and fed toward the support unit 30 by rotating the roll body R in one direction (the counter-clockwise direction in FIG. 1) at the feeding unit 20.

The support unit 30 includes a first support unit 31, a second support unit 32, and a guide unit 33 that form a transport path of the medium M, a vibration unit 34 configured to cause the first support unit 31 to vibrate, and a vibration unit 34 configured to cause the guide unit 33 to vibrate. The first support unit 31, the second support unit 32, and the guide unit 33 are disposed side-by-side in the transport direction Y of the medium M. The first support unit 31 guides the medium M fed from the feeding unit 20 toward the second support unit 32, the second support unit 32 guides (supports) the medium M on which printing is to be performed, and the guide unit 33 guides the medium M on which printing has been performed downstream in the transport direction.

The transport unit 40 includes a driving roller 41 and a driven roller 42 having the width direction X serving as an axial direction, and a transport motor 43 that drives the driving roller 41. The driving roller 41 is disposed vertically below the transport path of the medium M, and the driven roller 42 is disposed vertically above the transport path of the medium M. Moreover, the transport unit 40 transports the medium M in the transport direction Y by rotating the driving roller 41 while the medium M is sandwiched between the driving roller 41 and the driven roller 42.

The printing unit 50 includes a guide shaft 51 that extends in the width direction X, a carriage 52 supported on the guide shaft 51, and a discharge unit 53 configured to discharge ink onto the medium M. The carriage 52 reciprocates in the width direction X along the guide shaft 51 by the driving of a carriage motor (not illustrated). The discharge unit 53 is a discharging head on which a plurality of nozzles are formed, and is supported by the carriage 52 to face the medium M supported by the second support unit 32. Moreover, in the printing unit 50, ink is discharged from the discharge unit 53 while the carriage 52 is moved in the width direction X, and thus one pass of printing is performed on the medium M transported by the transport unit 40.

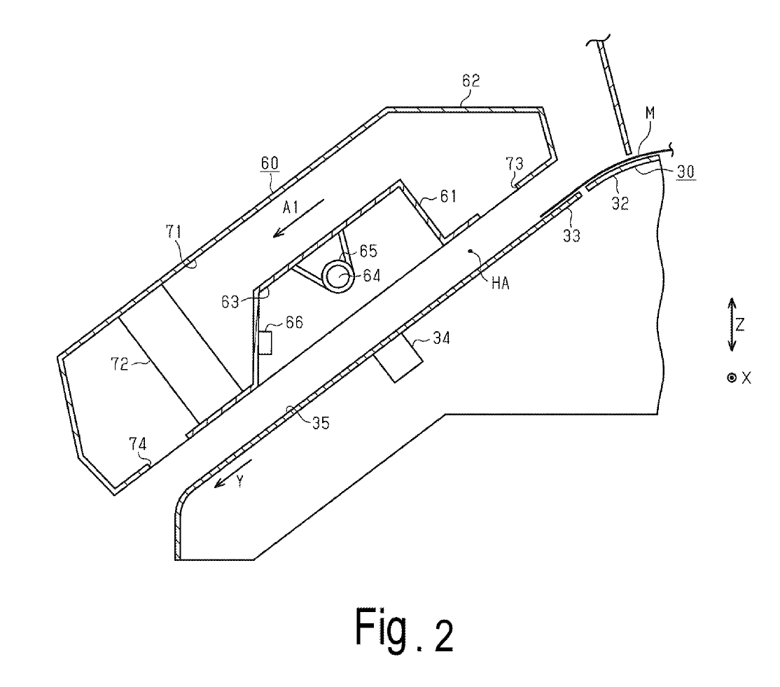

Next, the guide unit 33 and the vibration unit 34 will be described in detail with reference to FIG. 2.

As illustrated in FIG. 2, the guide unit 33 and the second support unit 32 are disposed in the transport direction Y with a space between the guide unit 33 and the second support unit 32. The guide unit 33 includes a guide surface 35 formed to be increasingly directed vertically downward while advancing in the transport direction Y. Note that the guide surface 35 may be a plane or a curved surface.

In the guide unit 33, the vibration unit 34 is provided on a side opposite to a side on which the guide surface 35 is formed. Note that, only one vibration unit 34 may be provided at a center of the guide unit 33 in the width direction X, or a plurality of vibration units 34 may be provided across the width direction X of the guide unit 33. Moreover, the vibration unit 34 causes the guide unit 33 to vibrate, thus applying vibration to the medium M guided to the guide surface 35. Note that, in the exemplary embodiment, the guide surface 35 vibrates when the guide unit 33 vibrates, and thus “the guide surface 35 vibrates” is also referred to as “the guide unit 33 vibrates”.

Further, the vibration unit 34 causes the guide unit 33 to vibrate, and examples of a vibration generating method by the vibration unit 34 include as follows, for example. To begin with, the vibration generating method by the vibration unit 34 may be a method for generating vibration by driving a motor having an output shaft provided with an eccentric weight (ERM: Eccentric Rotating Mass method). Further, another vibration generating method by the vibration unit 34 may be a method for utilizing vibration generated at a coil by causing a difference between an electromagnetic force caused depending on a value of current flowing in the coil and a repulsive force of the coil and a magnet to vary with time (LRA: Linear Resonant Actuator method). Furthermore, the vibration generating method by the vibration unit 34 may be a method for utilizing vibration generated by a piezoelectric element that expands or contracts depending on a value of applied voltage. Moreover, the vibration generating method by the vibration unit 34 may be a method for generating vibration through a vibrator that periodically moves using a high pressure gas as a power source.

Furthermore, the vibration unit 34 may cause the guide unit 33 to vibrate in a direction intersecting (desirably, a direction orthogonal to) the guide surface 35, for example, at a frequency from several tens to several thousands of Hz and with an amplitude of less than 1 mm. Herein, the vibration unit 34 may cause the guide unit 33 to vibrate with an amplitude of the guide plate 33 of less than 1 mm, for example, less than or equal to 15 m/S², and more desirably less than or equal to 10 m/S². However, an advantage of causing the guide unit 33 to vibrate is that the medium M adsorbed to the guide surface 35 is separated from the guide surface 35. Thus, a natural frequency of the medium M may be different from the frequency of vibration of the guide unit 33 to avoid the same vibration aspect of the medium M and the guide unit 33. Thus, in the exemplary embodiment, the vibration unit 34 causes the guide unit 33 to vibrate in a vibration aspect where the medium M guided by the guide unit 33 can be temporarily separated from the guide surface 35.

Note that specific examples of the medium M that allows the configuration of the vibration unit 34 to act on the above-mentioned guide unit 33 include, for example, a transparent polyethylene terephthalate (PET) film.

As illustrated in FIG. 1, the vibration unit 34 is also provided on the side opposite to the guide surface (the surface on which the medium M is guided) in the first support unit 31. The vibration unit 34 has the same configuration as the configuration of the vibration unit 34 provided on the above-mentioned guide unit 33 and can achieve the same action.

Next, the heating unit 60 will be described in detail with reference to FIG. 2.

As illustrated in FIG. 2, the heating unit 60 is configured to dry the medium M on which printing has been performed and is arranged to face the guide surface 35 of the guide unit 33. The heating unit 60 includes a lower frame 61 formed across the width direction X of the guide unit 33 and an upper frame 62 covering the lower frame 61 from vertically above. The lower frame 61 has a recess 63 being recessed toward the upper frame 62 across the width direction X.

Further, the heating unit 60 includes a heating element 64 having the width direction X serving as a longitudinal direction, a tube 65 in which the heating element 64 is inserted, and a temperature measuring unit 66 configured to measure a temperature of the guide surface 35 of the guide unit 33. The heating element 64 and the tube 65 are disposed in the recess 63 of the lower frame 61 so as to face the guide surface 35 of the transport unit 40. Further, the heating element 64 generates heat by energization and may be formed of, for example, an electrical heating wire. On the other hand, the tube 65 may have a high thermal conductivity and a high surface emissivity.

Further, the temperature measuring unit 66 is disposed in the recess 63 of the lower frame 61. The temperature measuring unit 66 detects, for example, the amount of infrared rays radiated from a detection region provided on the guide surface 35 to measure a temperature of the detection region. Note that the detection region may be, for example, only a region on the guide surface 35 facing the tube 65 of the heating unit 60, and a plurality of detection regions may be provided in the width direction X, or a plurality of detection regions may be provided in the transport direction Y. Note that when a region on the guide surface 35 in which the medium M is more likely to be adsorbed is known, a detection region may be provided upstream of that region in the transport direction.

Then, in the heating unit 60, when the tube 65 is heated by heat generated by the heating element 64, infrared rays which depend on the temperature of the tube 65 are radiated toward the guide surface 35 of the guide unit 33. The temperature of the medium M guided on the guide surface 35 then rises, causing solvent components of the ink discharged onto the medium M to evaporate. In this way, the heating unit 60 in the exemplary embodiment heats the medium M without contact by irradiating the medium M with infrared rays. Note that, in the following description, a region between the guide unit 33 and the heating unit 60 is also referred to as a “heated region HA” because the region is heated to dry the medium M.

Further, as illustrated in FIG. 2, the heating unit 60 includes a flow path 71 that circulates gas, a blowing unit 72 configured to blow gas, an intake port 73 through which gas is taken into the flow path 71, and a discharging port 74 through which gas is discharged from the flow path 71.

The flow path 71 is formed between the lower frame 61 and the upper frame 62 along the guide surface 35 of the guide unit 33. The blowing unit 72 is disposed at a position closer to the discharging port 74 than to the intake port 73 in the flow path 71. The blowing unit 72 blows gas taken in from the intake port 73 side toward the discharging port 74 side to form a gas flow in a first airflow direction A1 in the flow path 71. Note that the blowing unit 72 may be a centrifugal fan or an axial fan. Further, only one or a plurality of the blowing units 72 may be disposed in the width direction X.

The intake port 73 is open toward the guide surface 35 on an upstream side in the transport direction of the guide unit 33, and the discharging port 74 is open toward an end portion of the guide surface 35 on a downstream side in the transport direction of the guide unit 33. Thus, it can be said that the intake port 73 is open at an upstream end of the flow path 71 and the discharging port 74 is open at a downstream end of the flow path 71 in the first airflow direction A1.

Next, a control unit 100 will be described.

As illustrated in FIG. 1, the printing device 10 includes the control unit 100 configured to comprehensively control the device. The temperature measuring unit 66 is coupled to an interface at an input side of the control unit 100. The feeding unit 20, the transport motor 43, the discharge unit 53, the vibration unit 34, the heating element 64, and the blowing unit 72 are coupled to an interface at an output side of the control unit 100.

Moreover, the control unit 100 causes a transport operation, in which the medium M is transported by a unit transport amount, and a printing operation, in which ink is discharged from the discharge unit 53 while moving the carriage 52 in the width direction X, to be alternately performed to perform printing. Note that the unit transport amount in the transport operation is set to be less than a length of a nozzle row formed in the transport direction in the discharge unit 53, and the printing operation causes printing of one pass. Further, the control unit 100 acquires a temperature of the heated region HA based on a detection result of the temperature measuring unit 66 and controls driving of the vibration unit 34 provided on the guide unit 33 and the heating unit 60 (the heating element 64 and the blowing unit 72). Moreover, the control unit 100 controls driving of the vibration unit 34 provided on the first support unit 31.

In the printing device 10 including the guide unit 33 configured to guide the medium M on which printing has been performed, static electricity due to friction between the medium M being transported and the guide surface 35 may cause the medium M to be electrostatically adsorbed to the guide surface 35. Thus, in the exemplary embodiment, when the medium M is electrostatically adsorbed to the guide surface 35, the control unit 100 causes the guide unit 33 to vibrate to separate the medium M from the guide surface 35.

Specifically, when the medium M is electrostatically adsorbed to the guide surface 35, the medium M downstream of a portion (hereinafter also referred to as a “first portion M1”) of the medium M electrostatically adsorbed to the guide surface 35 may not be transported. On the other hand, transportation of the medium M on the upstream side in the transport direction continues, and thus a portion of the medium M (hereinafter also referred to as a “second portion M2”) upstream of the first portion M1 in the transport direction floats from the guide surface 35 (is bent). Then, the temperature of the medium M is more likely to rise with a shorter distance from the medium M floating from the guide surface 35 to the tube 65.

Therefore, in the exemplary embodiment, when the temperature of the medium M rises, the control unit 100 determines that the medium M is electrostatically adsorbed to the guide surface 35, based on a detection result of the temperature measuring unit 66, and causes the guide unit 33 to vibrate. Specifically, when a measured temperature of the temperature measuring unit 66 is greater than or equal to a preset specified value, the control unit 100 may determine that floating of the medium M has occurred.

Herein, the specified value is set to a temperature higher than the temperature of the medium M being guided by the guide unit 33 without being adsorbed to the guide surface 35. Also in this regard, in the exemplary embodiment, the temperature measuring unit 66 corresponds to one example of a “detector” configured to detect floating of the medium M from the guide surface 35.

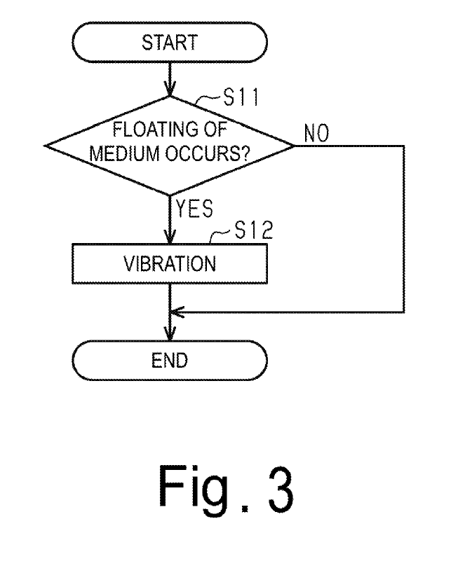

Next, a processing routine executed by the control unit 100 to cause the vibration unit 34 to vibrate will be described with reference to the flowchart illustrated in FIG. 3. Note that the processing routine is a processing routine executed at every preset control cycle.

As illustrated in FIG. 3, in the processing routine, the control unit 100 determines whether floating of the medium M on the guide surface 35 of the guide unit 33 occurs, based on a measurement result of the temperature measuring unit 66 (Step S11). When floating of the medium M does not occur (NO in Step S11), that is, when a temperature of the detection region of the temperature measuring unit 66 is less than the specified value, the control unit 100 terminates the processing routine.

On the other hand, when floating of the medium M occurs (YES in Step S11), that is, when a temperature of the detection region of the temperature measuring unit 66 is greater than or equal to the specified value, the control unit 100 drives the vibration unit 34 and causes the guide unit 33 to vibrate (Step S12). Subsequently, the control unit 100 terminates the processing routine.

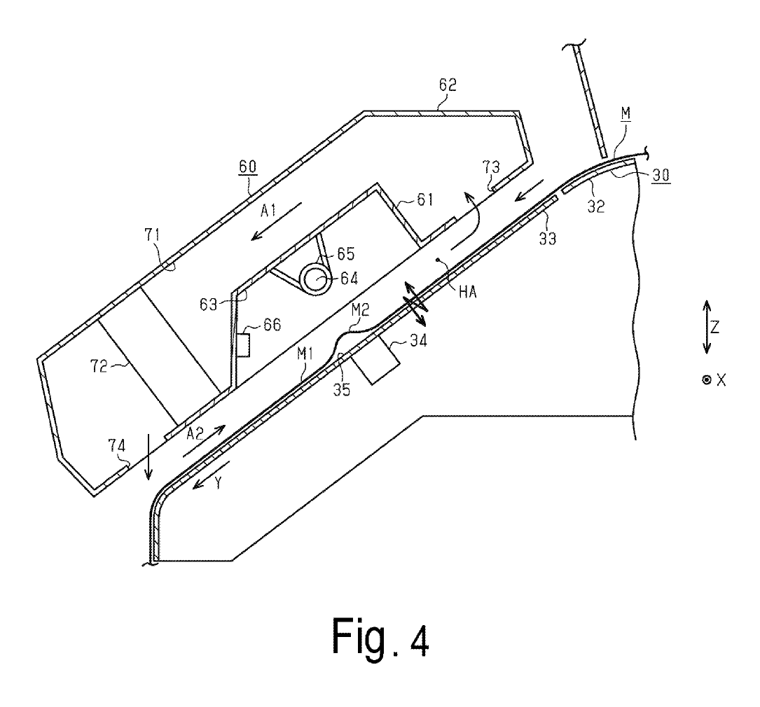

Next, action of the printing device 10 in the exemplary embodiment will be described with reference to FIGS. 2 and 4 while focusing on operations of the heating unit 60 and the guide unit 33. Note that FIG. 4 illustrates a direction in which gas flows by a thin arrow without a reference sign.

In the printing device 10 in the exemplary embodiment, when printing is performed on the medium M, the transport operation by the transport unit 40 and the printing operation by the printing unit 50 are alternately performed. Then, as illustrated in FIG. 2, the medium M on which printing has been performed is transported downstream in the transport direction while being guided by the guide unit 33.

On the other hand, the energization to the heating element 64 is started in the heating unit 60. Thus, infrared rays are radiated from the tube 65 heated by the heating element 64 toward the medium M guided by the guide unit 33, and the medium M is then heated. As a result, the solvent components of the ink discharged onto the medium M evaporate, and a character and an image printed onto the medium M become fixed to the medium M.

Further, as illustrated in FIG. 4, driving of the blowing unit 72 is started in the heating unit 60. In this way, airflow to the first airflow direction A1 is generated in the flow path 71, and thus gas is taken into the flow path 71 through the intake port 73 and discharged from the flow path 71 through the discharging port 74. Further, a flow of gas to a second airflow direction A2 opposite to the first airflow direction A1 is generated in the heated region HA by taking gas near the intake port 73 into the flow path 71 through the intake port 73.

As a result, the gas in the heated region HA containing many solvent vapors of ink by heating the medium M on which printing has been performed is taken into the flow path 71 through the intake port 73 and is then discharged to outside of the heated region HA through the discharging port 74. Thus, when printing continues, a gradual increase in the amount of solvent vapors of ink contained in the gas in the heated region HA is suppressed, and a decrease in efficiency of drying the medium M is suppressed.

Further, as illustrated in FIG. 4, when the first portion M1 of the medium M is electrostatically adsorbed to the guide surface 35, causing the second portion M2 upstream of the first portion M1 in the transport direction to float from the guide surface 35, the temperature of the second portion M2 increases, and thus the vibration unit 34 is driven.

Accordingly, as indicated by a thick arrow in FIG. 4, the guide unit 33 is vibrated, and then the medium M (the first portion M1) is separated from the guide surface 35, a state where the medium M is adsorbed to the guide surface 35 is eliminated. In other words, the medium M can be transported in the transport direction Y without being adsorbed to the guide surface 35, and a transport failure of the medium M is eliminated.

According to the exemplary embodiment described above, the following advantages are obtained.

(1) The guide surface 35 on which the medium M on which printing has been performed is caused to vibrate, and thus electrostatic adsorption of the medium M to the guide surface 35 can be suppressed and the medium M electrostatically adsorbed to the guide surface 35 can be separated from the guide surface 35. Thus, a medium M, such as a mesh-like medium M made of resin, in which static electricity is generated by sliding on the guide surface 35, and through which gas easily passes, can be transported while electrostatic adsorption to the guide surface 35 is suppressed.

Further, since the guide surface 35 is formed to be increasingly directed vertically downward while advancing in the transport direction Y, the medium M on which gravity acts is more likely to be guided in the transport direction Y. Accordingly, the transport failure of the medium M at the guide unit 33 can be suppressed.

(2) For example, when the medium M is heated by heat transfer from the guide surface 35 guiding the medium M, that is, when contact heating is performed on the medium M, efficiency of heating the medium M is more likely to decrease because a period in which the medium M is not in contact with the guide surface 35 occurs when the guide surface 35 is caused to vibrate. On the other hand, in the above-described exemplary embodiment, the medium M is heated without contact, and thus efficiency of heating the medium M is less likely to decrease even if the period in which the medium M is not in contact with the guide surface 35 occurs when the guide surface 35 is caused to vibrate. Accordingly, even when the medium M guided to the guide surface 35 is heated, a decrease in efficiency of heating the medium M due to the vibration of the guide surface 35 can be suppressed.

(3) The medium M is heated by irradiating the medium M with infrared rays, and thus the configuration of the printing device 10 can be simplified in comparison with a case where the medium M is heated by blowing hot air onto the medium M.

(4) Based on a detection result of the temperature measuring unit 66, when the medium M floats from the guide surface 35, the guide surface 35 is caused to vibrate to separate the medium M electrostatically adsorbed to the guide surface 35 from the guide surface 35. Thus, the guide surface 35 does not have to be continuously caused to vibrate because the guide surface 35 is caused to vibrate when the transport failure of the medium M occurs.

(5) The guide surface 35 of the guide unit 33 is a plane without unevenness or the like. Thus, the medium M when being transported is less likely to be caught by the unevenness, and the transport failure of the medium M can be less likely to occur.

The same advantage as the advantage of suppressing the transport failure of the medium M due to the vibration of the vibration unit 34 provided on the guide unit 33 described above can also be obtained by the vibration of the vibration unit 34 provided on the first support unit 31. Thus, the transportation of the medium M in the transport path of the printing device 10 can be further stabilized.

Further, a heating means for heating the medium M guided by the first support unit 31 is provided. Thus, the medium M can be preheated immediately before the medium M is guided by the second support unit 32 and the printing unit 50 performs printing, and printing quality can be improved. In this case, the medium M guided by the first support unit 31 may have a moment at which the medium M leaves the guide surface of the first support unit 31 due to the vibration of the vibration unit 34. Thus, the heating means may heat the medium M (and the first support unit 31) without contact by, for example, a method for irradiating the medium M with infrared rays similarly to the above-mentioned heating unit 60, instead of being disposed on the first support unit 31.

Note that the above-described exemplary embodiment may be modified as follows.

The heating unit 60 may be a heating unit without the flow path 71 and the blowing unit 72. Even in this case, the guide unit 33 is formed to be increasingly directed vertically downward while advancing in the transport direction Y, and thus gas heated in the heated region HA is more likely to rise vertically upward along the guide surface 35. Therefore, a gradual increase in the amount of solvent vapors of ink in the gas in the heated region HA can be suppressed, and a decrease in efficiency of drying the ink can be suppressed. Note that convection due to stack effect can also be expected in the heated region HA in the above-described exemplary embodiment.

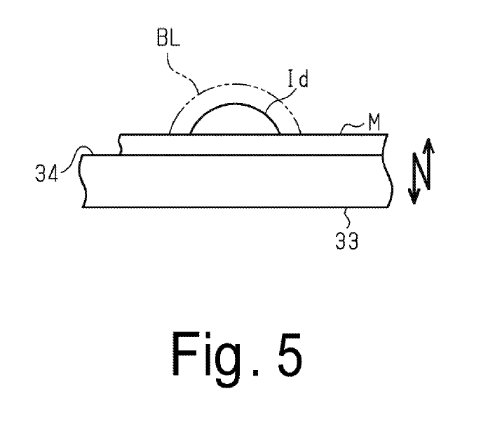

As illustrated in FIG. 5, when gas does not flow into the heated region HA or a flow of gas in the heated region HA is weak, a boundary layer BL of temperature or humidity is formed around an ink droplet Id discharged onto the medium M, and solvent components of the ink droplet Id may be less likely to be evaporated. Even in this case, gas in the boundary layer BL is mixed with gas outside the boundary layer BL by causing the guide unit 33 to vibrate as indicated by a thick line in FIG. 5, and thus the boundary layer BL can be destroyed. Therefore, even when gas does not flow into the heated region HA or only a weak flow of gas flows into the heated region HA, not only the solvent components of the ink droplet Id discharged onto the medium M can be prevented from being hardly evaporated, but also the advantage of causing the solvent components to be easily evaporated is obtained. Furthermore, by causing the guide unit 33 to vibrate, molecules of ink components collide with each other in the ink droplet Id discharged onto the medium M, which causes the temperature of the ink to increase, and thus the advantage of accelerating evaporation of the solvent components (volatile components) is obtained. These advantages can suppress a decrease in efficiency of drying the medium M even when the guide surface 35 is not inclined and the heating unit 60 does not include the flow path 71 and the blowing unit 72.

When the transport unit 40 is caused to vibrate during the printing operation, the aspect of supporting the medium M in the second support unit 32 may be affected, and thus printing quality may be affected. Thus, the control unit 100 may not cause the transport unit 40 to vibrate during the printing operation.

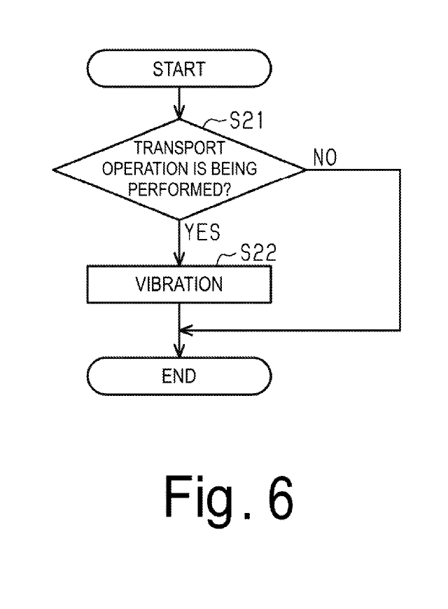

Next, a processing routine executed by the control unit 100 to cause the vibration unit 34 to vibrate will be described with reference to the flowchart illustrated in FIG. 6. As illustrated in FIG. 6, in the processing routine, the control unit 100 determines whether the transport operation is being performed (Step S21). When the transport operation is not being performed (NO in Step S21), that is, when the printing operation is being performed, the control unit 100 terminates the processing routine. On the other hand, when the transport operation is being performed (YES in Step S21), the control unit 100 drives the vibration unit 34 and causes the guide unit 33 to vibrate (Step S22).

In this way, the medium M dose not vibrate due to the vibration of the guide unit 33 during the printing operation, and thus a decrease in printing quality due to the vibration of the medium M can be suppressed.

When the guide surface 35 is caused to vibrate just in the transport operation, the transportation may start after the vibration of the guide unit 33 starts, or the vibration of the medium M may start after the transportation starts.

Note that the guide unit 33 may be caused to vibrate both when the printing operation is performed and when the transport operation is performed. In this case, the vibration unit 34 causes the guide unit 33 to vibrate under vibration conditions where the aspect of supporting the medium M in the second support unit 32 is not affected, that is, where printing quality is not adversely affected. In this way, the vibration is continuously applied to the medium M after printing, and drying of the ink droplet Id discharged onto the medium M after printing is stably promoted. Therefore, occurrence of the transport failure of the medium M can be suppressed while an increase in transport speed of the medium M can increase print efficiency, and a lower set temperature of the heating unit 60 can suppress thermal damage to the medium M and power consumption of the heating unit 60.

Further, when the guide surface 35 is caused to vibrate just in the transport operation, the guide surface 35 may not be caused to vibrate when the medium M is not electrostatically adsorbed to the guide surface 35. In other words, the processing in Step S11 in the flowchart illustrated in FIG. 3 may be performed between the processing in step S21 and the processing in step S22 in the flowchart illustrated in FIG. 6.

On the other hand, the guide surface 35 may be continuously caused to vibrate in the transport operation and the printing operation. In this case, a configuration preventing transmission of vibration may be provided downstream of the printing unit 50 and upstream of the guide unit 33 in the transport direction Y in order not to transmit the vibration of the guide surface 35 to the medium M supported by the second support unit 32. Note that examples of the configuration preventing transmission of vibration include the driving roller 41 and the driven roller 42 in the above-described exemplary embodiment.

The control unit 100 may drive the vibration unit 34 at every preset control cycle regardless of a detection result of the temperature measuring unit 66. For example, the control unit 100 may drive the vibration unit 34 when a transport amount of the medium M after the vibration unit 34 is previously driven is greater than or equal to a predetermined transport amount, or may drive the vibration unit 34 when an elapsed time after the vibration unit 34 is previously vibrated is greater than or equal to a predetermined elapsed time.

The printing device 10 may have a configuration including an excitation condition setting means for setting an excitation condition (the number of vibrations and amplitude) of the guide unit 33 and the first Support unit 31 by the vibration unit 34 to an optimum excitation condition for each type of the medium M. For example, a “printing setting” means of the printing device 10 may include a “medium type selecting means”, an operator may change an excitation condition based on information about a type of the medium specified by the “medium kind selecting means”, and the printing device 10 may be controlled by the control unit 100 based on the excitation condition.

The temperature measuring unit 66 may be a detector configured to directly detect the amount of floating of the medium M guided on the guide surface 35 from the guide surface 35. In this case, the control unit 100 may determine that the transport failure of the medium M occurs when the amount of floating from the guide surface 35 is greater than or equal to a predetermined amount of floating. For example, examples of such a detector include a reflective or transmissive photoelectric sensor.

An imaging unit configured to capture a front surface or a back surface of the medium M over time during transportation of the medium M may be included. In this case, the control unit 100 may calculate an actual transport amount as a real transport amount of the medium M based on an image captured by the imaging unit, and calculate a control transport amount based on the number of rotations of the transport motor 43. The control unit 100 may determine that the transport failure of the medium M has occurred when there is a difference between the control transport amount and the actual transport amount, and drive the vibration unit 34.

The heating unit 60 may heat an airflow in the heated region HA. In this case, the medium M is heated by heat transfer by the airflow.

The heating unit 60 may not be provided. Even in this case, occurrence of the transport failure of the medium M can be suppressed.

The guide surface 35 may not guide the medium M while contacting a back surface (a surface opposite to a print surface) of the medium M. In other words, the guide unit 33 may guide the medium M while contacting a front surface (the print surface) of the medium M.

In the guide surface 35, a plurality of ribs having the transport direction Y serving as the longitudinal direction and having the width direction X serving as a lateral direction may be formed, or a plurality of the recesses 63 or convex portions may be formed. In this case, the plurality of ribs and tip portions of the plurality of recesses and convex portions form the guide surface 35.

The guide surface 35 may not be formed to be increasingly directed vertically downward while advancing in the transport direction Y. For example, the guide surface 35 may be formed horizontally or may be formed to be increasingly directed vertically upward while advancing in the transport direction Y.

The vibration unit 34 may not cause the entire guide unit 33 to vibrate as long as the vibration unit 34 can vibrate at least the guide surface 35.

The aspect in which the vibration unit 34 vibrates the guide unit 33 (guide surface 35) may be appropriately changed according to a thickness, a mass, or a natural frequency of the medium M to be transported.

The medium M is not limited to the above-mentioned PET film, and may be a sheet of printing paper, a plastic film, or a fiber used for a textile printing device and the like. Further, the medium M may not be a long medium M fed from the roll body R. For example, the medium M may be a single sheet of paper.

In the above-described exemplary embodiment, the recording material used in the printing may be a fluid other than ink (including, for example, liquids, liquid materials obtained by dispersing or mixing particles of a functional material in a liquid, fluid materials like a gel, and solids that can flow and be discharged as a fluid). For example, a configuration may be adopted in which a liquid material including a material such as an electrode material and a color material (pixel material) used in the manufacture of liquid crystal displays, electroluminescent (EL) displays, surface emitting displays, and the like in a dispersed or dissolved form is discharged for recording.

The discharge unit 53 (printing head) may be a so-called line head that has a length in the width direction X longer than a length in the width direction X of all media M being print targets of the printing device 10 and that is fixed and disposed on the printing device 10.

In the above-described exemplary embodiment, the printing device 10 is not limited to a printer that performs recording by discharging ink, and may be a non-impact printer such as a laser printer, a LED printer, and a thermal transfer printer (including a sublimation type printer), or may be an impact printer such as a dot impact printer.

Next, technical ideas that can be understood from the above-described exemplary embodiment and the modified example are added below.

When a medium on which printing has been performed is heated by irradiation with infrared rays, if no flow of gas is formed around the medium, or the flow of gas around the medium is weak, a boundary layer of temperature or humidity is formed around the medium, and the medium may be less likely to be dried. In other words, when the medium is heated by irradiation with infrared rays, efficiency of drying the medium may decrease due to an environment around the medium.

A printing device that eliminates the above-described issue includes a transport unit configured to transport a medium, a printing unit configured to perform printing on the medium transported by the transport unit, a guide unit including a guide surface that guides the medium on which printing has been performed, a heating unit configured to irradiate the medium with infrared rays, and a vibration unit configured to cause the guide surface to vibrate.

According to the above-described configuration, the guide surface is vibrated, and thus a boundary layer of temperature or humidity formed around the medium is destroyed, and the medium is prevented from becoming unlikely to dry. Therefore, according to this configuration, even when the medium is heated by irradiation, a decrease in efficiency of drying the medium can be suppressed regardless of an environment around the medium.

The entire disclosure of Japanese Patent Application No. 2016-047944, filed Mar. 11, 2016 is expressly incorporated by reference herein.

### REFERENCE SIGNS LIST

10 . . . Printing device, 20 . . . Feeding unit, 21 . . . Holding member, 30 . . . Support unit, 31 . . . First support unit, 32 . . . Second support unit, 33 . . . Guide unit, 34 . . . Vibration unit, 35 . . . Guide surface, 40 . . . Transport unit, 41 . . . Driving roller, 42 . . . Driven roller, 43 . . . Transport motor, 50 . . . Printing unit, 51 . . . Guide shaft, 52 . . . Carriage, 53 . . . Discharge unit, 60 . . . Heating unit, 61 . . . Lower frame, 62 . . . Upper frame, 63 . . . Recess, 64 . . . Heating element, 65 . . . Tube, 66 . . . Temperature measuring unit (one example of detector), 71 . . . Flow path, 72 . . . Blowing unit, 73 . . . Intake port, 74 . . . Discharging port, 100 . . . Control unit, A1 . . . First airflow direction, A2 . . . Second airflow direction, BL . . . Boundary layer, HA . . . Heated region, Id . . . Ink droplet, M . . . Medium, M1 . . . First portion, M2 . . . Second portion, R . . . Roll body, X . . . Width direction, Y . . . Transport direction, Z . . . Vertical direction

1. A printing device comprising:
a transport unit configured to transport a medium in a transport direction;
a printing unit configured to perform printing on the medium transported by the transport unit;
a guide unit including a guide surface that guides the medium on which printing has been performed; and
a vibration unit configured to cause the guide surface to vibrate, wherein
the guide surface is formed to be increasingly directed vertically downward while advancing in the transport direction.

2. The printing device according to claim 1, further comprising:
a heating unit configured to heat the medium without contact.

3. The printing device according to claim 2, wherein
the heating unit is configured to irradiate the medium with infrared rays.

4. The printing device according to claim 1, further comprising:
a detector configured to detect floating of the medium from the guide surface; and
a control unit configured to cause the guide surface to vibrate when floating of the medium from the guide surface occurs.

5. The printing device according to claim 2, further comprising:
a detector configured to detect floating of the medium from the guide surface; and
a control unit configured to cause the guide surface to vibrate when floating of the medium from the guide surface occurs.

6. The printing device according to claim 3, further comprising:
a detector configured to detect floating of the medium from the guide surface; and
the control unit is configured to cause the guide surface to vibrate both when floating of the medium from the guide surface occurs.

7. The printing device according to claim 1, further comprising:
a control unit configured to alternately perform a transport operation in which the medium is transported in the transport direction and a printing operation in which printing is performed on the medium, wherein
the control unit is configured to cause the guide surface to vibrate when the transport operation is performed, whereas the control unit is configured not to cause the guide surface to vibrate when the printing operation is performed.

8. The printing device according to claim 2, further comprising:
a control unit configured to alternately perform a transport operation in which the medium is transported in the transport direction and a printing operation in which printing is performed on the medium, wherein
the control unit is configured to cause the guide surface to vibrate when the transport operation is performed, whereas the control unit is configured not to cause the guide surface to vibrate when the printing operation is performed.

9. The printing device according to claim 3, further comprising:
a control unit configured to alternately perform a transport operation in which the medium is transported in the transport direction and a printing operation in which printing is performed on the medium, wherein
the control unit is configured to cause the guide surface to vibrate when the transport operation is performed, whereas the control unit is configured not to cause the guide surface to vibrate when the printing operation is performed.

10. The printing device according to claim 4, further comprising:
a control unit configured to alternately perform a transport operation in which the medium is transported in the transport direction and a printing operation in which printing is performed on the medium, wherein
the control unit is configured to cause the guide surface to vibrate when the transport operation is performed, whereas the control unit is configured not to cause the guide surface to vibrate when the printing operation is performed.

11. The printing device according to claim 5, further comprising:
a control unit configured to alternately perform a transport operation in which the medium is transported in the transport direction and a printing operation in which printing is performed on the medium, wherein
the control unit is configured to cause the guide surface to vibrate when the transport operation is performed, whereas the control unit is configured not to cause the guide surface to vibrate when the printing operation is performed.

12. The printing device according to claim 6, further comprising:
a control unit configured to alternately perform a transport operation in which the medium is transported in the transport direction and a printing operation in which printing is performed on the medium, wherein
the control unit is configured to cause the guide surface to vibrate when the transport operation is performed, whereas the control unit is configured not to cause the guide surface to vibrate when the printing operation is performed.

13. The printing device according to claim 1, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.

14. The printing device according to claim 2, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.

15. The printing device according to claim 3, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.

16. The printing device according to claim 4, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.

17. The printing device according to claim 5, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.

18. The printing device according to claim 6, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.

19. The printing device according to claim 7, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.

20. The printing device according to claim 8, further comprising:
a control unit configured to perform a transport operation in which the medium is transported in the transport direction, perform a printing operation in which printing is performed on the medium, and cause the guide surface to vibrate, wherein
the control unit is configured to cause the guide surface to vibrate both when the transport operation is performed and when the printing operation is performed.
